(19) United States
(12) Patent Application Publication
(10) Pub. No.: US 2013/0300660 A1
(43) Pub. Date: Nov. 14, 2013

(54) CURSOR CONTROL SYSTEM

(71) Applicant: Kuang-Cheng Chao, New Taipei City (TW)

(72) Inventor: Kuang-Cheng Chao, New Taipei City (TW)

(73) Assignee: AMTRAN TECHNOLOGY CO., LTD., New Taipei City (TW)

(21) Appl. No.: 13/543,894

(22) Filed: Jul. 9, 2012

(30) Foreign Application Priority Data
May 11, 2012 (TW) 101116930

(51) Int. Cl. G06F 3/033

(52) U.S. Cl. 345/158

(57) ABSTRACT

A cursor control system is provided. A cursor position information is calculated according to a position information and an axial information of a hand held device. The display displays the cursor or executes a corresponding operating instruction according to the cursor position information.

### CROSS-REFERENCE TO RELATED APPLICATION

This application claims the priority benefit of Taiwan application serial no. 101116930, filed on May 11, 2012. The entirety of the above-mentioned patent application is hereby incorporated by reference herein and made a part of this specification.

### BACKGROUND OF THE INVENTION

1. Field of the Invention

The invention relates to a control system and more particularly, to a cursor control system.

2. Description of Related Art

With recent advancements of technologies, a wide range of household electronic devices such as television, air conditioner, electric fan and digital video disc-DVD are provided with a remote control. At present, the most common remote signal is an infrared signal having directivity. Generally, in conventional technology, a remote-control device has an infrared transmitter, while the electronic device has two infrared cameras. Infrared cameras may detect an infrared signal transmitted from the infrared transmitter on the remote-control device. A relative location of the remote-control device corresponding to the electronic device may be obtained by analyzing result of the infrared signal detected by the infrared cameras. Accordingly, the electronic device may be controlled by changing the relative location of remote-control device corresponding to the electronic device. For example, it is assumed that the electronic device is a computer, in which a cursor displayed on screen moves along with the remote-control device.

In conventional technology, although the remote-control device may effectively control the electronic device, when displacement variation of the remote-control device and cursor movement of the electronic device are in a 1:1 correspondence, a wide range of displacement variation of the remote-control device is required in order to perform a wide range of cursor movement. When displacement variation of the remote control and cursor movement of the electronic device are not in a 1:1 correspondence, the accuracy of remote-control device may be affected thereby. Either way, convenience of using the remote-control device may be greatly reduced.

### SUMMARY OF THE INVENTION

The invention provides a cursor control system, which may prevent reduction in convenience of using the remote-control device due to limitation of displacement variation.

A cursor control system is provided, which is adapted for controlling a cursor on a display. The cursor control system includes a hand held device and a cursor position calculating device. Wherein the hand held device includes a plurality of reference light sources, a gyroscope and a signal transmitting module. Wherein the gyroscope detects a rotational state of the hand held device for obtaining an axial information. The signal transmitting module is coupled to the gyroscope, converting the axial information to a wireless signal. The cursor position calculating device includes an image capturing module, a signal receiving module and a processing unit. Wherein the image capturing module captures an image of the reference light sources. The signal receiving module receives the wireless signal. The processing unit is coupled to the image capturing module and the signal receiving module, calculating a cursor position information according to the image of the reference light sources and the wireless signal, and the display displays the cursor according to the cursor position information.

In an embodiment of the invention, the gyroscope is a pitch-detectable gyroscope for obtaining the axial information by detecting a pitch angle between the hand held device and a vertical axis.

In an embodiment of the invention, the image capturing module includes a first image capturing unit and a second image capturing unit. Wherein the first image capturing unit captures an image of the reference light sources. The second image capturing unit captures the image of the reference light source, wherein a relative position between the first image capturing unit and the second image capturing unit is fixed. The cursor position information is calculated by the processing unit according to the relative position between the first image capturing unit and the second image capturing unit.

In an embodiment of the invention, wherein the reference light sources are infrared light sources, and the wireless signal is a Bluetooth signal or a radio frequency (RF) signal.

The invention further provides a cursor control system, adapted for controlling a cursor on a display. The cursor control system includes a hand held device and a cursor position calculating device. The hand held device includes a plurality of reference light sources, a gyroscope and a signal transmitting module. The gyroscope detects a rotational state of the hand held device for obtaining an axial information. The signal transmitting module is coupled to the gyroscope, converting the axial information to a wireless signal. The cursor position calculating device includes an image capturing module, a signal receiving module and a processing unit. Wherein the image capturing module captures an image of the reference light sources. The signal receiving module receives the wireless signal. The processing unit is coupled to the image capturing module and the signal receiving module, calculating a cursor position information according to the image of the reference light sources and the wireless signal, and the display displays the cursor according to the cursor position information.

In an embodiment of the invention, the display displays the cursor according to the cursor position information indicating that the cursor is located inside a screen region of the display. The display executes a corresponding operating instruction according to the cursor position information indicating that the cursor is located outside the screen region of the display.

In an embodiment of the invention, the image capturing module includes a first image capturing unit and a second image capturing unit. The image capturing module captures an image of the reference light sources. The second image capturing unit, configured to capture an image of the reference light source, wherein a relative position between the first image capturing unit and the second image capturing unit is fixed, and the cursor position information is calculated by the processing unit according to the relative position between the first image capturing unit and the second image capturing unit.

In an embodiment of the invention, wherein the reference light source is infrared light source, and the wireless signal is a Bluetooth signal or a radio frequency (RF) signal.

In an embodiment of the invention, the hand held device includes a gyroscope. The gyroscope detects a pitch angle between the hand held device and a vertical axis.

Base on the above, by calculating the cursor position information according to the position information and the axial information of the hand held device, and displaying the cursor on the display or executing the corresponding operating instruction according to the cursor position information, the invention may prevent reduction in convenience of using the remote-control device due to limitation of displacement variation.

To make the aforementioned and other features and advantages of the invention more comprehensible, several embodiments accompanied with figures are described in detail below.

### BRIEF DESCRIPTION OF THE DRAWINGS

FIG. 1 is a schematic diagram illustrating a cursor control system according to an embodiment of the invention.

FIGS. 2A to 2C are schematic diagrams illustrating a rotational state of a hand held device according to an embodiment of the invention.

FIGS. 3A and 3B are schematic diagrams illustrating an image of the reference light sources formed on a charged coupled device of an infrared camera.

FIG. 4 is a schematic diagram illustrating a relative position between an image of the reference light source formed on the charged coupled device of the infrared camera and the reference light source in three dimensional space.

FIG. 5 is a schematic diagram illustrating a calculation of the position of the reference light source in three-dimensional space according to an embodiment of the invention.

FIG. 6 is a schematic diagram illustrating a cursor control system according to another embodiment of the invention.

FIG. 7 is a schematic diagram illustrating an input control of the cursor control system according to an embodiment of the invention.

FIG. 8 is a schematic diagram illustrating a cursor control system according to another embodiment of the invention.

### DESCRIPTION OF THE EMBODIMENTS

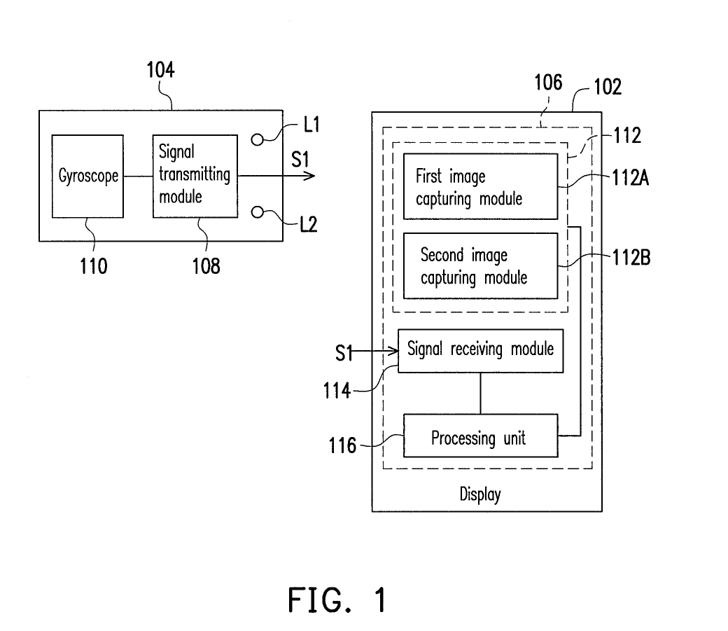

FIG. 1 is a schematic diagram illustrating a cursor control system according to an embodiment of the invention. Referring to FIG. 1, the cursor control system includes a hand held device 104 and a cursor position calculating device 106. The cursor control system is adapted for controlling a cursor on a display 102, wherein the hand held device 104 may be an input device of the display 102. The display 102 is a common display device (such as a liquid crystal display or a plasma display panel) used for displaying an image on the display screen. The hand held device 104 includes reference light sources L1 and L2, a signal transmitting module 108 and a gyroscope 110, wherein the gyroscope 110 is coupled to the signal transmitting module 108. The gyroscope 110 is configured to detect a rotational state of the hand held device 104 for obtaining an axial information. The signal transmitting module 108 converts the axial information to a wireless signal S1 for sending to the cursor position calculating device 106. In an embodiment of the invention, the reference light sources L1 and L2, for example, may be infrared emitting diodes, and the wireless signal S1, for example, may be a Bluetooth signal or a radio frequency (RF) signal. The gyroscope 100, for example, may be a vertical gyroscope, which is used for obtaining said axial information by detecting a pitch angle between the hand held device 104 and a vertical axis. Further, the signal transmitting module 108, for example, may be a Bluetooth transmitter.

In addition, the cursor position calculating device 106 may be disposed on the display 102, including an image capturing module 112, a signal receiving module 114 and a processing unit 116, wherein the processing unit 116 is coupled to the image capturing module 112 and the signal receiving module 114. The signal receiving module 114, for example, may be a Bluetooth receiver and the image capturing module, for example, may be infrared cameras. The image capturing module 112 is configured to capture an image of the reference light sources L1 and L2. The signal receiving module 114 is configured to receive the wireless signal S1. The processing unit 116 calculates a cursor position information according to the image of the reference light sources L1 and L2 and the wireless signal S1, so that the display 102 may display the cursor on the display screen and executes a corresponding operating instruction according to the cursor position information.

For example, the display 102 displays the cursor according to the cursor position information indicating that the cursor is located inside a screen region of the display 102; and the display 102 executes operation such as volume control or switching channel according to the cursor position information indicating that the cursor is located outside the screen region of the display 102.

As described above, the processing unit 116 may respectively obtain the position information and the axial information of the hand held device 104 from the image of the reference light sources L1 and L2 and the wireless signal S1. The cursor position information may be further calculated according to the position information and the axial information, such that the display 102 may execute a different operation according to the cursor position information. Therefore, user may remotely control the display 102 by simply rotating the hand held device 104, without moving the position of the the hand held device 104. Accordingly, reduction in convenience of using the remote-control device due to limitation of displacement variation may be prevented.

Furthermore, the image capturing module 112 may include a first image capturing unit 112A and a second image capturing unit 112B, wherein a relative position between the first image capturing unit 112A and the second image capturing unit 112B is fixed. In an embodiment of the invention, the first image capturing unit 112A and the second image capturing unit 112B are infrared cameras. The first image capturing unit 112A and the second image capturing unit 112B may respectively capture an image of the reference light sources L1 and L2. The position of the reference light sources L1 and L2 in three-dimensional space is calculated by the processing unit 116 according to the image capturing results of the first image capturing unit 112A and the second image capturing unit 112B and the relative position between the first image capturing unit 112A and the second image capturing unit 112B. In addition to the position of the hand held device 104, a rotation angle of the hand held device in a specific direction may also be obtained by the position variation of the reference light sources L1 and L2 in three-dimensional space. Since the calculation result of the cursor remains the same after the hand held device 104 is rotated 180 degrees, in the case where the rotation angle is greater than 180 degrees, only the angle minus 180 degrees is considered. That is, the result of calculation of the cursor is not affected by swapping of the positions of L1 and L2.

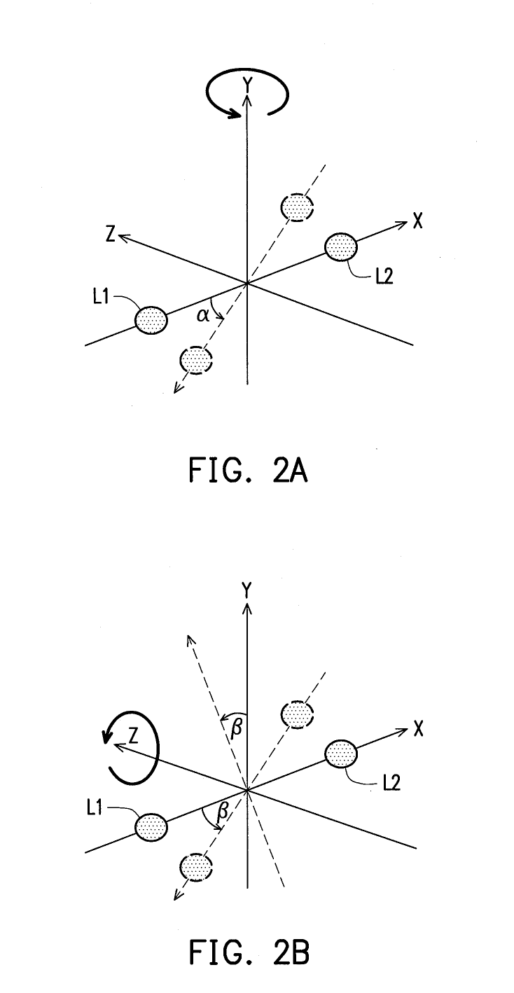

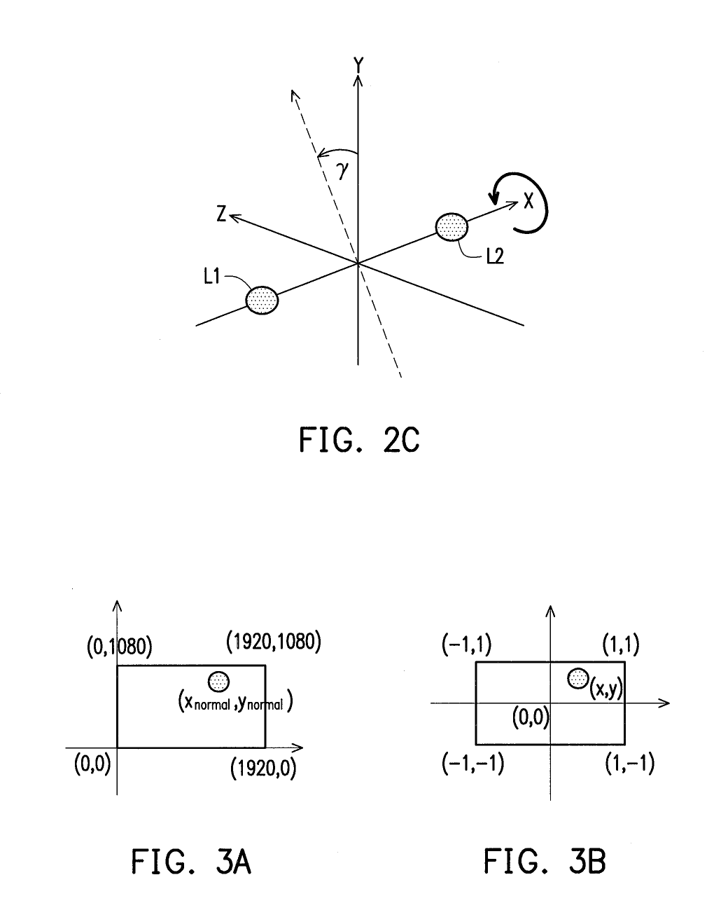

For example, FIGS. 2A and 2B are schematic diagrams illustrating a rotational state of a hand held device according to an embodiment of the invention. As shown in FIG. 2A, when the vertical axis (i.e. the Y-axis) is used as a rotating axis of the hand held device 104, the variation of a rotation angle (the rotation angle a as shown in FIG. 2A) of the hand held device 104 may be obtained by detecting the position variation of the reference light sources L1 and L2. Wherein the Y-axis is vertical to a straight line between the reference light source L1 and the reference light source L2 (i.e. the X-axis). In addition, as shown in FIG. 2B, in the case where a Z-axis is used as the rotating axis of the hand held device 104, the variation of the rotation angle of the hand held device 104 may also be obtained by detecting the position variation of the reference light sources L1 and L2. Since the calculation result of the cursor remains the same after the hand held device 104 is rotated 180 degrees, in the case where the rotation angle is greater than 180 degrees, only the angle minus 180 degrees is considered. That is, the result of calculation of the cursor is not affected by swapping of the positions of L1 and L2. Wherein the Z-axis (longitudinal axis), the X-axis (lateral axis) and the Y-axis (vertical axis) are vertical to each other.

In addition to the rotational state of the hand held device 104 obtained by the processing unit 116 according to the calculation of the reference light sources L1 and L2, the axis information (which may not be obtained according to the calculation of the reference light sources L1 and L2) may also be obtained by the processing unit 116 from the wireless signal S1 received by the signal receiving module 114. For example, FIG. 2C is a schematic diagram illustrating the rotational state of the hand held device according to the embodiment of the invention. As shown in FIG. 2C, when the straight line between the reference light source L1 and the reference light source L2 (i.e. the X-axis) is used as the rotating axis of the hand held device 104, the variation of the rotation angle (for example, a tilt angle as shown in FIG. 2B is γ, which means that the rotation angle of the hand held device is also γ) of the hand held device 104 may be obtained by detecting an included angle between the hand held device 104 and the vertical axis. When a pitch angle is greater than 90 degrees, the cursor calculated using within such pitch angle has no reference value.

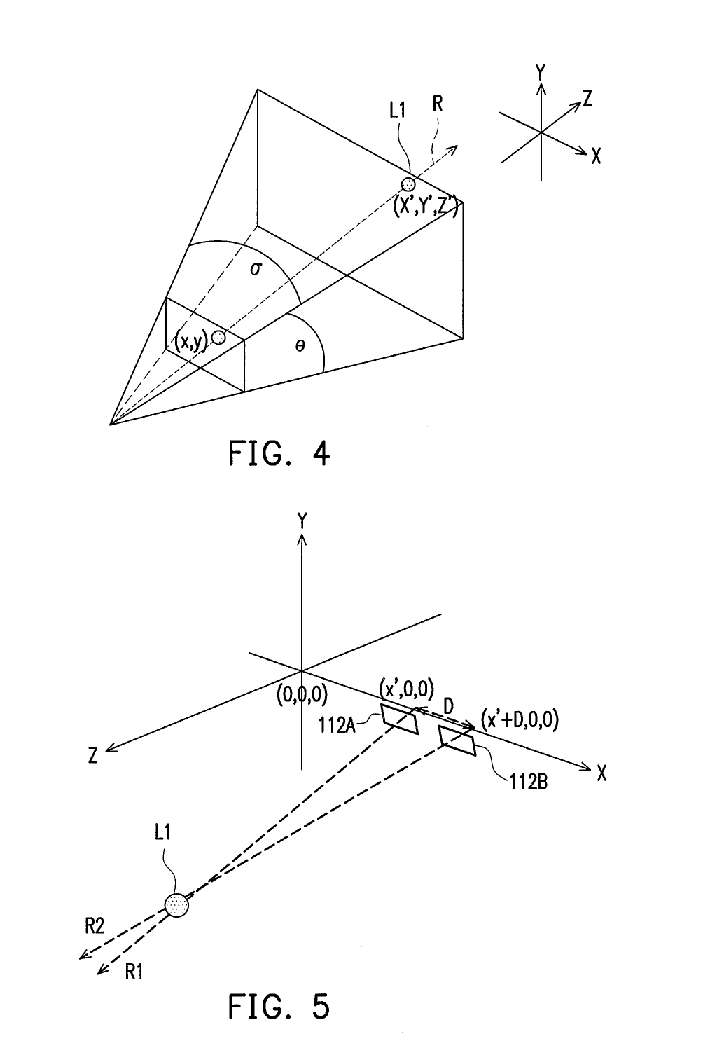

Particularly, a method for calculating the position of the reference light sources L1 and L2 in a three-dimensional space using the processing unit 116 is as described below. FIGS. 3A and 3B are schematic diagrams illustrating an image of the reference light sources formed on a charged coupled device of an infrared camera. FIG. 4 is a schematic diagram illustrating a relative position between an image of the reference light source L1 formed on the charged coupled device of the infrared camera and the reference light source L1 in three dimensional space. Referring to FIG. 3A, FIG. 3B and FIG. 4 together, each one of the pixels on the charged coupled device of the infrared camera has a ray R corresponding thereto. Normalization may be performed to the coordinates in order to ensure all of the pixels on the charged coupled device are laid within the range of [−1, +1] (as shown in FIG. 3B). After normalization is completed, the relation of original pixel coordinate xₙₒᵣₘₐₗ and normalized coordinate x, and the the relation of original pixel coordinate yₙₒᵣₘₐₗ and normalized coordinate y may be expressed by the following formula:

$$\begin{matrix}x = \frac{2 \times {x}_{normal}}{{Pixels}_{x}} - 1 & ( 1 ) \\ y = \frac{2 \times {y}_{normal}}{{Pixels}_{y}} - 1 & ( 2 )\end{matrix}$$

Wherein Pixelsₓ indicates amount of the transverse pixels on the charged coupled device, whereas Pixels_{y} indicates amount of the longitudinal pixels on the charged coupled device. The coordinates (X′, Y′, Z′) of the pixels on the charged coupled device in three-dimensional space may be expressed by the following formula:

X′=x*tan(σ/2)

Y′=y*tan(σ/2)

Z′=1 (3)

Wherein a horizontal angle σ and a vertical angle θ are internal parameters of the infrared camera, which determines the direction of the ray R.

FIG. 5 is a schematic diagram illustrating calculation of the position of the reference light source L1 in three-dimensional space according to an embodiment of invention. As shown in FIG. 5, in which a distance between the two infrared cameras (i.e. the first image capturing unit 112A and the second image capturing device 112B) is D. Two rays R1 and R2 corresponding to the reference light source L1 may be obtained by the value detected by the two infrared cameras. The coordinates of the reference light source L1 in three-dimensional space may then be obtained by obtaining the intersection point of the rays R1 and R2. In FIG. 5, the coordinates of the first image capturing unit 112A are (x′, 0, 0) and the coordinates of the second image capturing unit 112B are (x′+D, 0, 0). The rays R1 and R2 may be expressed by the following formula:

R1=\vec{o}₁+\vec{d}₁×t₁

R2=\vec{o}₂+\vec{d}₂×t₂ (4)

\vec{o}₁=(x′, 0, 0)

\vec{o}₂=(x′+D, 0, 0)

\vec{d}₁=(X₁, Y₁, Z₁)

\vec{d}₂=(X₂, Y₂, Z₂)

Wherein, t₁, t₂ ∈ R>0

In addition, t₁ and t₂ may be expressed by the following formula:

$${\hat{t}}_{1} = \frac{det ( \begin{matrix}{\vec{o}}_{2} - {\vec{o}}_{1} & {\vec{d}}_{2} & {\vec{d}}_{1} \times {\vec{d}}_{2}\end{matrix} )}{{\vert {\vec{d}}_{1} {\times }^{′} {\vec{d}}_{2} \vert}^{2}} \\ {\hat{t}}_{2} = \frac{det ( \begin{matrix}{\vec{o}}_{2} - {\vec{o}}_{1} & {\vec{d}}_{1} & {\vec{d}}_{1} \times {\vec{d}}_{2}\end{matrix} )}{\vert {\vec{d}}_{1} {\times }^{′} {\vec{d}}_{2} \vert} \qquad ( 5 )$$

The three-dimensional coordinates of the reference light source L1 is calculated by averaging the rays R1 and R2, the coordinates may be expressed by the following formula:

$$\frac{{\vec{o}}_{1} + {\vec{d}}_{1} {\hat{t}}_{1} + {\vec{o}}_{2} + {\vec{d}}_{2} {\hat{t}}_{2}}{2} \qquad ( 6 )$$

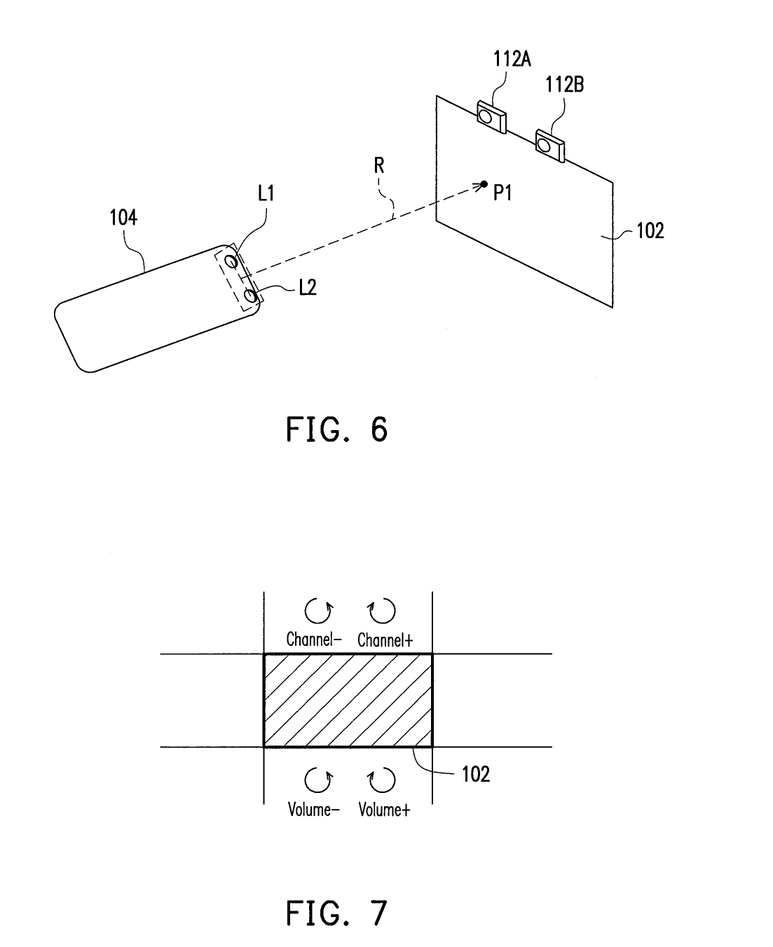

Similarly, the three-dimensional coordinates of the reference light source L2 may also obtained with the same method, which is omitted herein. A completed position information and a completed axis information of the hand held device 104 may be obtained by calculating the positions of the reference light source L1 and the reference light source L2 and the result detected by the gyroscope 110, thereby obtaining the cursor position information. For example, FIG. 6 is a schematic diagram illustrating a cursor control system according to another embodiment of the invention. In FIG. 6, the reference light source L1 and the reference light source L2 are disposed on the front end of the remote control (i.e. the hand held device 104), and the gyroscope 110 (not illustrated, however, it is a pitch-detectable gyroscope in the present embodiment) is built-in to the remote control. Wherein a tilt angle detected by the gyroscope 110 is 0 degree when a major axis direction of the remote control is parallel to a vertical axis thereof, and normal vector of a plane where the reference light source L1 and the reference light source L2 are disposed on, is parallel to the major axis direction of the remote control.

In addition, a virtual indicating point P1 is a point generated by intersecting a ray R (which passes through a middle point of a straight line between the reference light source L1 and the reference light source L2 towards the direction parallel to normal vector of the plane where the reference light source L1 and the reference light source L2 are disposed on) with a plane where the display 102 is located thereto. Wherein the position of the virtual indicating point P1 is related to the position information and the axis information of the remote control (i.e. the hand held device 104).

Particularly, after normal vector (assumed that it is (a, b, c)) of the plane where the reference light source L1 and the reference light source L2 are disposed on has been determined, the point (x″, y″, z″) (i.e. the virtual indicating point P1) which is generated by intersecting the ray (the direction thereof is parallel to normal vector (a, b, c)) that passes though the middle point (assumed the coordinates are (x₀, y₀, z₀)) of the straight line between the reference light source L1 and the reference light source L2, with the plane where the display 102 is located thereto (i.e. the plane where Z=0), may be expressed by the following formula:

$$\{ \begin{matrix}{x}^{″} = - {z}_{0} \times \frac{a}{c} + {x}_{0} \\ {y}^{″} = - {z}_{0} \times \frac{b}{c} + {y}_{0} \\ {z}^{″} = 0\end{matrix} \qquad ( 7 )$$

As a result, an input control to the display 102 may be performed by intuitively moving or rotating the remote control. For example, when user moves or rotates the remote control to locate the virtual indicating point P1 inside of the display screen of the display 102, the display is controlled by the processing unit 116 to display a cursor on where the virtual indicating point P1 is located. As a result, user may move the cursor to the selecting area on the display interface, and an operating instruction may be sent to the display 102 using bottoms on the remote control.

Alternatively, when virtual indicating point P1 is located outside the screen region of the display 102, the display 102 is controlled by the processing unit 116 to execute an operating instruction corresponding to the position information and the axis information of the remote control (i.e. the hand held device 104). For example, FIG. 7 is a schematic diagram illustrating an input control of the cursor control system according to an embodiment of the invention. As shown in FIG. 7, the plane where the display 102 is located may be divided into several areas. For example, the area outside the screen region of the display 102 may be divided into 8 sections by extending the frame lines of the display 102. Accordingly, the display 120 may be configured to perform the corresponding operating instruction when the the virtual indicating point P1 is moved to a different area, such that user may have different controlling experience, and convenience in using the same may also be increased.

For example, an upper area of the display 102 may be configured as an area for switching channel control. When the virtual indicating point P1 is moved to the upper area of the display 102 by user, followed by performing a clockwise or a counterclockwise trace movement within the area, the channel may then be switched. Alternatively, a lower area of the display 102 may be configured to an area for volume control. When the virtual indicating point P1 is moved to the lower area of the display 102 by user, followed by performing a clockwise or a counterclockwise trace movement within the area, the volume may then be controlled.

It should be noted that, although the hand held device 104 is implemented by using two reference light sources L1 and L2 and a pitch-detectable gyroscope 110 in the above embodiments, the invention is not limited thereto. In some embodiments, the hand held device 104 may be implemented by using only one reference light source, and the gyroscope 110 may be implemented by using one attitude indicator (configured to detect the pitch angle and the roll angle) and one direction indicator (configured to detect the yaw angle), thereby obtaining three axis informations (i.e. the axis informations corresponding to the X-axis, the Y-axis and the Z axis of the hand held device 104) of the hand held device.

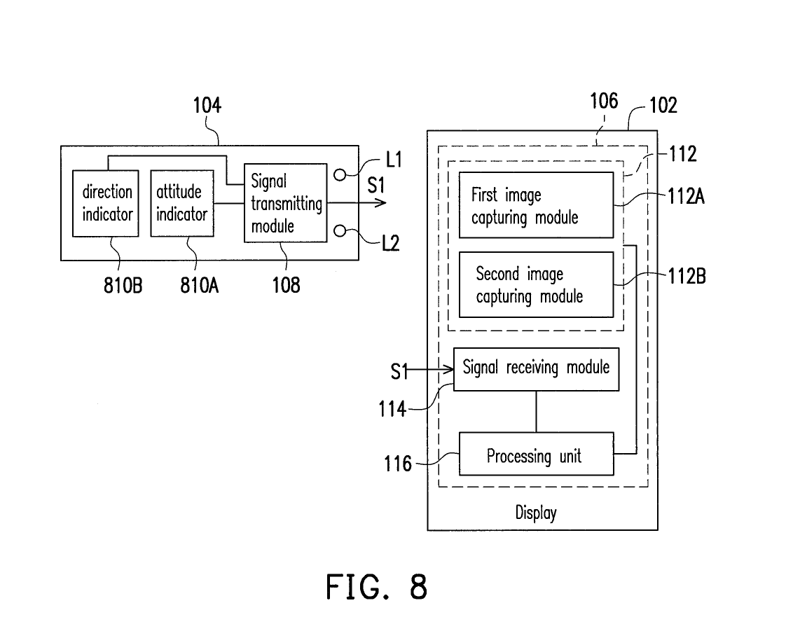

FIG. 8 is a schematic diagram illustrating a cursor control system according to another embodiment of the invention. Referring to FIG. 8, the difference between the present embodiment and embodiment of FIG. 1 lies in that, the reference light source in the hand held device 104 of the present embodiment only includes a reference light source L3, and the gyroscope includes an attitude indicator 810A and a direction indicator 810B. Wherein the attitude indicator 810A is configured to detect the pitch angle and the roll angle of the hand held device 104, and the direction indicator 810B is configured to detect the yaw angle of the hand held device 104.

In brief, the first image capturing unit 112A and the second image capturing unit 112B may respectively capture an image of the reference light sources L3 for obtaining the position information of the hand held device 104. The signal transmitting module 108 is coupled to the attitude indicator 810A and the direction indicator 810B, respectively transmitting the axis informations detected by the attitude indicator 810A and the direction indicator 810B to the signal receiving module 114, as to indicate a rotational state of the hand held device 104. In addition, in the present embodiment, a relative position between the first image capturing unit 112A and the second image capturing unit 112B is fixed. Accordingly, a position information of the hand held device 104 may be calculated by the processing unit 116 according to the relative position between the first image capturing unit 112A and the second image capturing unit 112B. A cursor position information may be calculated according to axial informations detected by the attitude indicator 810A and the direction indicator 810B. Wherein, the method for obtaining the position information and the axis information of the hand held device 104 is similar to that in the above embodiments, those ordinarily skilled in the art should be able to infer from the above embodiments, thus it is omitted herein. It should be noted that, although the three axis informations of the hand held device 104 are obtained by using two gyroscopes in the present embodiment, the invention is not limited thereto. In other embodiments, the three axis informations of the hand held device 104 obtained by using single gyroscope or three gyroscopes, which is also possible. That is, as long as the three axis informations of the hand held device 104 may be obtained, the amount of gyroscope used is not limited.

Base on the above, by calculating the cursor position information according to the position information and the axial information of the hand held device, and displaying the cursor on the display or executing the corresponding operating instruction according to the cursor position information, the invention may prevent reduction in convenience of using the remote-control device due to limitation of displacement variation.

Although the invention has been described with reference to the above embodiments, it is apparent to one of the ordinary skill in the art that modifications to the described embodiments may be made without departing from the spirit of the invention. Accordingly, the scope of the invention will be defined by the attached claims not by the above detailed descriptions.

What is claimed is:

1. A cursor control system, adapted for controlling a cursor on a display, the cursor control system comprises:
a hand held device, comprising:
a plurality of reference light sources;
a gyroscope, configured to detect a rotational state of the hand held device for obtaining an axial information; and
a signal transmitting module, coupled to the gyroscope, converting the axial information to a wireless signal; and
a cursor position calculating device, comprising:
an image capturing module, configured to capture an image of the reference light sources;
a signal receiving module, configured to receive the wireless signal; and
a processing unit, coupled to the image capturing module and the signal receiving module, calculating a cursor position information according to the image of the reference light sources and the wireless signal, and the display displaying the cursor according to the cursor position information.

2. The cursor control system of claim 1, wherein the display displays the cursor according to the cursor position information indicating that the cursor is located inside a screen region of the display, and the display executes a corresponding operating instruction according to the cursor position information indicating that the cursor is located outside the screen region of the display.

3. The cursor control system of claim 1, wherein the gyroscope is a pitch-detectable gyroscope for obtaining the axial information by detecting a pitch angle between the hand held device and a vertical axis.

4. The cursor control system of claim 1, wherein the image capturing module comprises:
a first image capturing unit, configured to capture an image of the reference light sources; and
a second image capturing unit, configured to capture an image of the reference light sources, wherein a relative position between the first image capturing unit and the second image capturing unit is fixed, and the cursor position information is calculated by the processing unit according to the relative position between the first image capturing unit and the second image capturing unit.

5. The cursor control system of claim 1, wherein the reference light sources are infrared light sources, and the wireless signal is a Bluetooth signal or a radio frequency (RF) signal.

6. A cursor control system, adapted for controlling a cursor on a display, the cursor control system comprises:
a hand held device, comprising:
a reference light source;
at least one gyroscope, configured to detect a rotational state of the hand held device for obtaining three axial informations; and
a signal transmitting module, coupled to the at least one gyroscope, converting the axial informations to a wireless signal; and
a cursor position calculating device, comprising:
an image capturing module, configured to capture an image of the reference light source;
a signal receiving module, configured to receive the wireless signal; and
a processing unit, coupled to the image capturing module and the signal receiving module, calculating a cursor position information according to the image of the reference light source and the wireless signal, and the display displaying the cursor according to the cursor position information.

7. The cursor control system of claim 6, wherein the display displays the cursor according to the cursor position information indicating that the cursor is located inside a screen region of the display, and the display executes a corresponding operating instruction according to the cursor position information indicating that the cursor is located outside the screen region of the display.

8. The cursor control system of claim 6, wherein the image capturing module comprises:
a first image capturing unit, configured to capture an image of the reference light source; and
a second image capturing unit, configured to capture an image of the reference light source, wherein a relative position between the first image capturing unit and the second image capturing unit is fixed, and the cursor position information is calculated by the processing unit according to the relative position between the first image capturing unit and the second image capturing unit.

9. The cursor control system of claim 6, wherein the reference light sources is infrared light source, and the wireless signal is a Bluetooth signal or a RF signal.

10. The cursor control system of claim 6, wherein the hand held device comprises:
an attitude indicator, configured to detect a pitch angle and a roll angle of the hand held device; and
a direction indicator, configured to detect a yaw angle of the hand held device.
